(19) United States
(12) Patent Application Publication
(10) Pub. No.: US 2006/0070077 A1
(43) Pub. Date: Mar. 30, 2006

(54) Providing custom product support for a software program

(75) Inventors: Aaron E. Erlandson, Redmond, WA (US); Benjamin E. Canning, Seattle, WA (US); Steven M. Greenberg, Seattle, WA (US); Thomas S. Coon, Kirkland, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/206,387

(22) Filed: Aug. 17, 2005

Related U.S. Application Data
(63) Continuation-in-part of application No. 10/955,421, filed on Sep. 30, 2004.

(51) Int. Cl. G06F 9/46

(52) U.S. Cl. 718/104

(57) ABSTRACT

The system described herein provides providing application support by receiving data indicating application run-time characteristics, determining severity of errors associated with running the application based on the data, and determining if there are resources available to provide application support. The system may also determine if the application passes integrity checks. If the severity of application errors exceeds a predetermined threshold and there are resources available for free application support, then the system may provide free application support. A queue may be used for instances of eligibility for free application support. Free application support may be provided by either telephone or online interaction.

### CROSS-REFERENCE TO RELATED APPLICATIONS

This application is a continuation-in-part of U.S. patent application Ser. No. 10/955,421 filed on Sep. 30, 2004 and titled: “METHOD, SYSTEM, AND APPARATUS FOR PROVIDING CUSTOM PRODUCT SUPPORT FOR A SOFTWARE PROGRAM BASED UPON STATES OF PROGRAM EXECUTION INSTABILITY” (pending), which is incorporated by reference herein.

### BACKGROUND

An important stage in the software development cycle is the debugging stage that occurs after a software product has been shipped to customers. This stage is important because the actual experiences of users of the software product may be utilized during this stage to isolate program errors, identify frequently or infrequently used features, and to generally make the software product better and more stable. The main focus of analysis in the after-release debugging stage is typically to identify the program errors (also referred to herein as “bugs”) that occur most frequently. By identifying the most frequently occurring bugs and fixing them, the usability experience of many users can be improved.

There is another category of analysis, however, that has been generally unaddressed by previous after-release debugging systems. This category involves identifying computer systems that most frequently encounter problems during the execution of an application program. These problems may or may not include the program errors that occur most frequently amongst all users. Statistics show that a small number of users experience a high percentage of the total number of overall problems. Such problems may include program crashes, program hangs, abrupt program terminations, and other types of abnormal program terminations. Application programs that exhibit these types of problems are generally referred to herein as being “unstable” or having “program execution instability.” An unstable program can be particularly frustrating for the computer user that frequently encounters the problems while using the program.

Previous after-release debugging systems do not provide a way to identify computer systems having the highest frequency of program execution instability and therefore do not provide a mechanism for the software developer to assist the user experiencing the problems. In addition, in some cases it may be desirable for the software/system provider to be able to help such users without necessarily having to provide the same level of help to other users who may not be experiencing the same level of program execution instability.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The system described herein provides providing application support by receiving data indicating application run-time characteristics, determining severity of errors associated with running the application based on the data, and determining if there are resources available to provide application support. The system may also determine if the application passes integrity checks. If the severity of application errors exceeds a predetermined threshold and there are resources available for free application support, then the system may provide free application support. A queue may be used for instances of eligibility for free application support. Free application support may be provided by either telephone or online interaction.

The system may provide a queue for instances that merit application support, where each of the instances corresponds to application use by a user and the system may provide a plurality of specific instances to the queue based on predetermined criteria, where placement in the queue of a particular instance is not known by a corresponding user until application support is provided. In some embodiments, an instance may be removed from the queue prior to providing application support.

The system may also provide a queue for instances that merit application support, where instances are placed in the queue based on predetermined criteria, place a first instance in the queue, determine that a second instance should not be placed in the queue and provide alternative support, different from the application support, in connection with the second instance.

### BRIEF DESCRIPTION OF THE SEVERAL VIEWS OF THE DRAWINGS

FIG. 1 is a network diagram illustrating aspects of a computer network utilized to embody various aspects of the system described herein.

FIG. 2 is a computer system architecture diagram illustrating a computer system utilized in and provided by the various embodiments of the system described herein.

FIGS. 3-7 are flow diagrams illustrating processes provided by and utilized in the various embodiments of the system described herein.

FIG. 8 is a flow chart illustrating steps performed in connection with an exception handler according to an embodiment of the system described herein.

FIG. 9 is a flow chart illustrating steps performed in connection with manually invoking application diagnostics according to an embodiment of the system described herein.

FIG. 10 is a flow chart illustrating steps performed in connection with application diagnostics according to an embodiment of the system described herein.

FIG. 11 is a flow chart illustrating steps performed in connection with update diagnostics according to an embodiment of the system described herein.

FIG. 12 is a flow chart illustrating steps performed in connection with an audit process according to an embodiment of the system described herein.

FIGS. 13A and 13B are flow charts illustrating steps performed in connection with handling a new invocation of the system according to an embodiment described herein.

FIG. 14 is a flow chart illustrating steps performed in connection with diagnostics according to an embodiment of the system described herein.

FIG. 15 is a flow chart illustrating steps performed in connection with help functionality according to an embodiment of the system described herein.

FIG. 16 is a flow chart illustrating steps performed in connection with connecting to a remote computer to facilitate product support according to an embodiment of the system described herein.

FIG. 17 is a flow chart illustrating steps performed by a remote server in connection with facilitating product support according to an embodiment of the system described herein.

### DETAILED DESCRIPTION

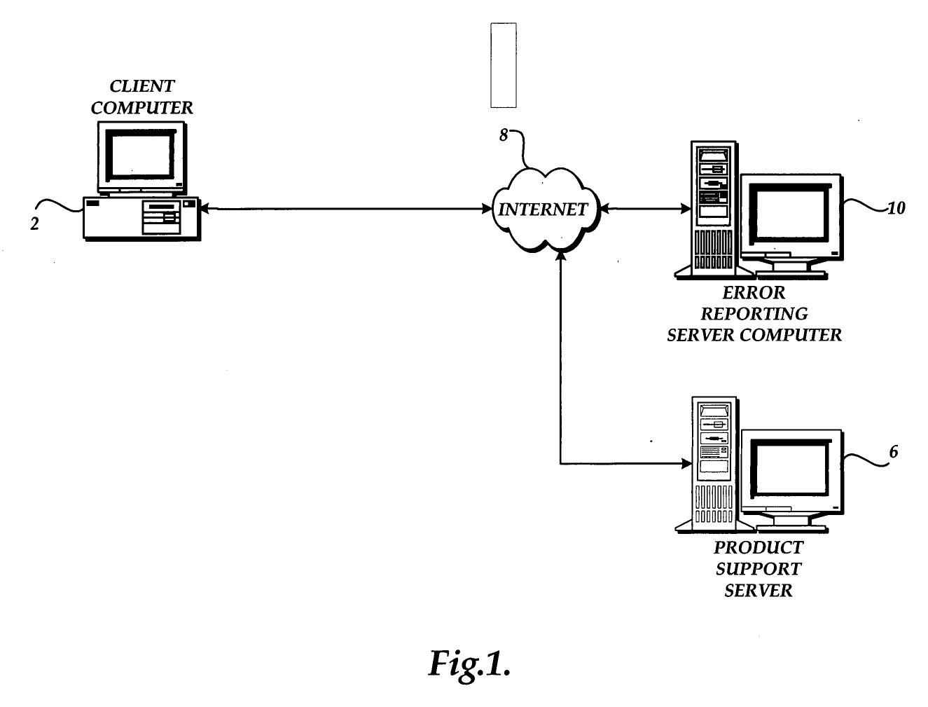

Referring now to the drawings, in which like numerals represent like elements, various aspects of the system described herein are provided. In particular, FIG. 1 and the corresponding discussion are intended to provide a brief, general description of a suitable computing environment in which embodiments of the system described herein may be implemented. While the system will be described in the general context of program modules that execute in conjunction with program modules that run on an operating system on a personal computer, those skilled in the art will recognize that the system described herein may also be implemented in combination with other types of computer systems and program modules.

Generally, program modules include routines, programs, components, data structures, and other types of structures that perform particular tasks or implement particular abstract data types. Moreover, those skilled in the art will appreciate that the system described herein may be practiced with other computer system configurations, including hand-held devices, multiprocessor systems, microprocessor-based or programmable consumer electronics, minicomputers, mainframe computers, and the like. The system described herein may also be practiced in distributed computing environments where tasks are performed by remote processing devices that are linked through a communications network. In a distributed computing environment, program modules may be located in both local and remote memory storage devices. Referring now to the drawings, in which like numerals represent like elements through the several figures, aspects of the system and the exemplary operating environment will be described.

FIG. 1 shows an illustrative operating environment for various embodiments of the system described herein. As shown in FIG. 1, a client computer 2 is utilized in the various embodiments of the system described herein. The client computer comprises a standard desktop or server computer that may be used to execute one or more program modules. The client computer 2 is also equipped with program modules for monitoring the execution of application programs and for determining the execution stability of the programs. The client computer 2 is also operative to classify the stability of the programs based on one or more threshold values and to provide custom product support for the applications based on the classification.

In order to classify the stability of the programs executing at the client computer 2, the client computer 2 is also operative to periodically receive a remote control file from an error reporting server computer 10, which may be operated by a developer of the software program or someone else tasked with providing the functionality described herein. The error reporting server computer 10 may include a conventional server computer maintained and accessible through a LAN or the internet 8. Additional details regarding the contents and use of the remote control file will be provided below with respect to the description herein. A product support server computer 6 may also provide custom product support. For instance, the product support server may provide web pages or other information based upon the level of program instability a user experiences.

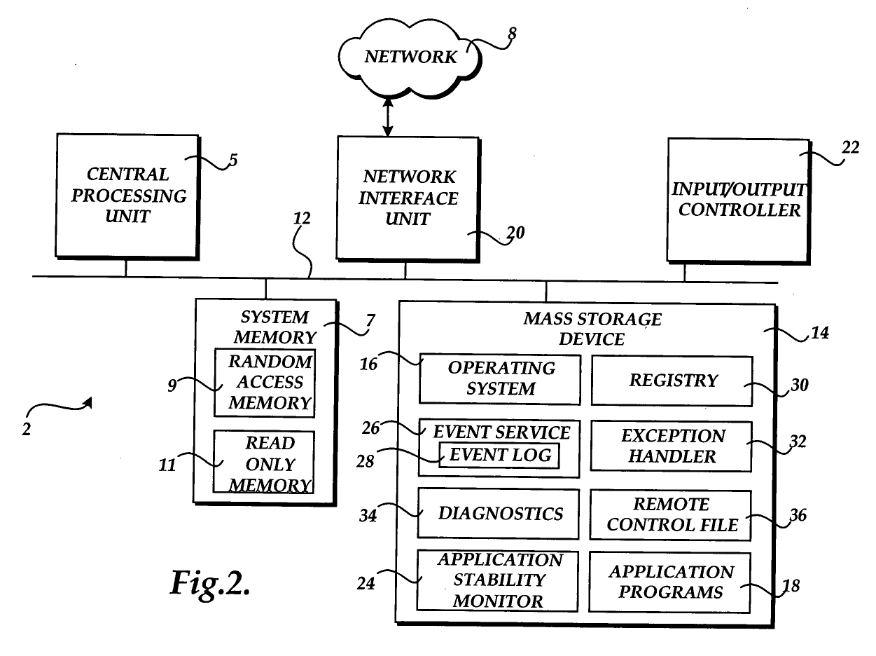

FIG. 2 illustrates computer architecture for a client computer 2 used in the various embodiments of the system described herein. The computer architecture shown in FIG. 2 illustrates a conventional desktop or laptop computer, including a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs 18, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the system described herein, the computer 2 may operate in a networked environment using logical connections to remote computers through a network 8, such as the internet. The client computer 2 may connect to the network 8 through a network interface unit 20 connected to the bus 12. It should be appreciated that the network interface unit 20 may also be utilized to connect to other types of networks and remote computer systems. The computer 2 may also include an input/output controller 22 for receiving and processing input from a number of other devices, including a keyboard, mouse, or electronic stylus (not shown in FIG. 1). Similarly, an input/output controller 22 may provide output to a display screen, a printer, or other type of output device.

As mentioned briefly above, a number of program modules and data files may be stored in the mass storage device 14 and RAM 9 of the computer 2, including an operating system 16 suitable for controlling the operation of a networked personal computer, such as the WINDOWS® XP operating system. The mass storage device 14 and RAM 9 may also store one or more program modules. In particular, the mass storage device 14 and the RAM 9 may store an application stability monitor program 24 for monitoring the execution stability of one or more of the application programs 18 and for providing custom product support for the application programs 18 if the program becomes unstable beyond certain settable thresholds. The application stability monitor 24 may be executed in response to the execution of an exception handler 32 that is operative to catch and handle program execution exceptions within the client computer 2. The application stability monitor 24 may also be executed manually by a user of the client computer 2.

In order to monitor the stability of the application programs 18, the application stability monitor 24 utilizes the services of an event service 26. The event service 26 is a facility provided by the operating system 26 for logging events occurring at the client computer 2 to an event log 28. For instance, the event service 26 may log security-related events (e.g. an unauthorized login attempt), system-related events (e.g. a disk drive experiencing failures), and application-related events. As will be described in greater detail below, events regarding the execution and failure of the application programs 18 are recorded in the event log 28. In particular, a session entry may be generated in the event log 28 each time an application program is executed. The session entry includes data identifying the program, the length of time the program was executed, and data indicating whether the program was terminated normally or abnormally. An abnormal termination may include a program crash, a program hang (where the program continues executing, but appears unresponsive to the user), or any other type of abnormal termination (such as if power was removed from the computer while the program was executing).

As will be described in greater detail below, the event log 28 may be periodically parsed and statistics generated that describe the stability of the application programs 18. The statistics may include data defining the number of abnormal terminations per number of program executions, the number of abnormal terminations per number of minutes of program execution may be calculated, or other types of statistics indicating the stability of the application programs 18.

Once the statistics have been generated, the execution stability of the programs may be categorized into states based upon the statistics and one or more threshold values stored in a remote control file 36. The threshold values define various levels of program instability. For example, threshold values may be defined that categorize the execution of a program module as “fine,” “bad,” or “very bad.” According to one embodiment of the system described herein, the “fine” threshold indicates that the application program is sufficiently stable that no action should be taken. The “bad” threshold indicates that the application program is somewhat unstable, but not unstable enough to warrant the provision of free or reduced fee product support to the user. The user may be directed to diagnostics or other information. The “very bad” threshold indicates that the application stability is so poor that free or reduced fee product support is warranted. It should be appreciated that more than three thresholds may be defined and the definitions of these thresholds may vary according to the software product and its developer. It should be appreciated that monitoring of the performance of the application program and the provision of custom support may be enabled by the developer of the application program on an application-by-application basis.

The contents of the remote control file 36 may be periodically updated and transmitted to the client computer 2 from the error reporting server computer 10. The remote control file 36 may also store expiration dates for each threshold defining a time after which the thresholds should not be utilized. The remote control file 36 may also store application version numbers for each of the thresholds. The application version numbers allow different thresholds to be assigned to different versions of an application program that may be installed and in use at the client computer 2. It should be appreciated that the remote control file 36 may store other data and may be utilized to control the operation of the client computer 2 in additional ways. More information regarding the content and use of the remote control file can be found in co-pending U.S. patent application Ser. No. 10/304,282, which is entitled “Method and System for Remotely Controlling the Reporting of Events Occurring within a Computer System” and which is expressly incorporated herein by reference.

Based upon the assigned threshold, custom program support may be provided for a user of the computer system executing the program by the application stability monitor 24. For instance, based on the categorization, the user may be directed to free or reduced fee product support. Alternatively, a user of the computer may be directed to an information resource, such as a web page, that is determined based upon the categorization. Likewise, a diagnostic program 34 may be executed to identify and repair problems with the computer system and the application program based upon the categorization.

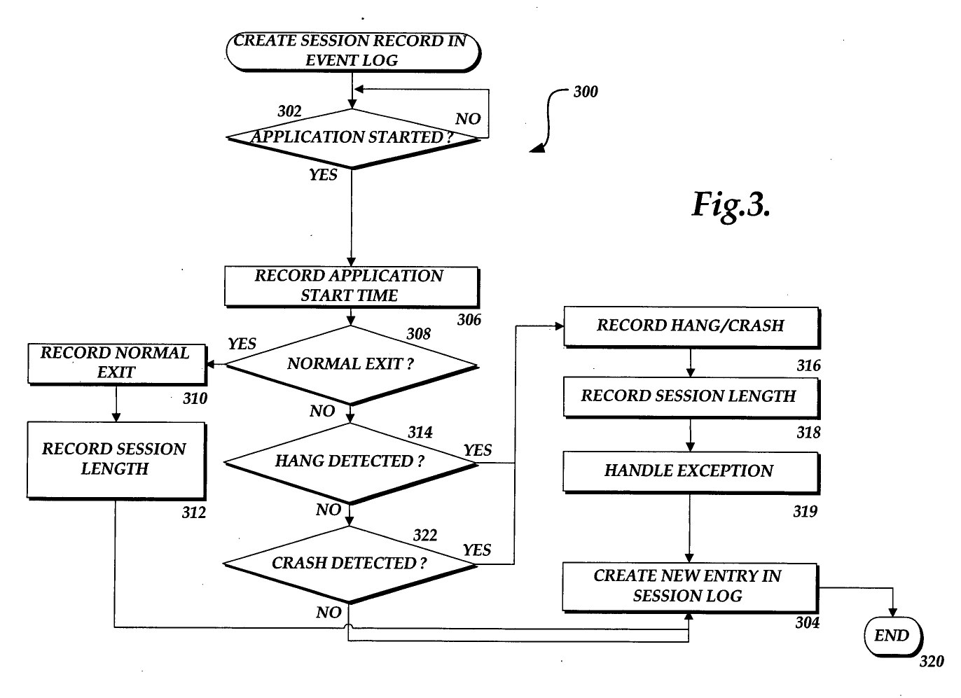

According to embodiments of the system described herein, the operating system 16 is operative to store data in a registry 30. The registry 30 is a central hierarchical database utilized to store information necessary to configure the client computer 2 for one or more users, applications, and hardware devices. For instance, the registry 30 is operative to store a “last fix time” registry key that identifies the last time which a repair was made to the software components on the client computer by the diagnostics 34. The registry 30 is further operative to store a “diagnostic state” registry key that identifies the current user's prior interactions with the application stability monitor 24. The possible values for the diagnostic state registry key are “new” where the user has not previously utilized the application stability monitor 24, “altered” where the diagnostics 34 were previously executed and changes were made to the client computer 2, “identified” where the diagnostics 34 were executed and it was determined that the problem causing the instability is external to the application programs 18 (e.g. such as a hardware failure), and “help” where diagnostics were executed and the user was directed to customer support in the form of a product support specialist (“PSS”). As will be described in greater detail below, the value of the “diagnostic state” registry key is utilized to determine how a newly encountered problem should be handled for a user. Additional details regarding creation of the event log 28, operation of the exception handler 32, and the operation of the application stability monitor 24 will be provided in greater detail below with respect to FIGS. 3-7.

Referring now to FIG. 3, an illustrative routine 300 will be described illustrating a process performed for creating records in the event log 28. When reading the discussion of the routines presented herein, it should be appreciated that the logical operations of various embodiments of the system described herein are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the system described herein. Accordingly, the logical operations illustrated herein may be referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein. Furthermore, it should be appreciated that while a particular order of operation is set forth with respect to the logical operations illustrated herein, other orders of operation are possible, unless indicated otherwise.

The routine 300 begins at operation 302, where a determination is made by the event service 26 as to whether one of the application program 18 has been started. If an application program has not been started, the routine 300 returns to decision operation 302, where another determination is made. If an application program has been started, the routine 300 continues to operation 306, where the time the application was started is stored in memory

From operation 306, the routine 300 continues to operation 308, where the event service 26 determines whether the application program was exited normally, such as in response to a user request. If the application program exited normally, the routine 300 continues to operation 310, where data is stored in memory indicating that the application exited normally. The routine 300 then continues to operation 312, where the length of time the application executed during the session is recorded to in memory. The routine 300 then continues from operation 312 to operation 304 where a new entry is created in the event log 28 for the current application session (“a session entry”). The data recording in memory regarding the execution of the program is then stored in the session entry. These operations may be performed within an exception handler. From operation 304, the routine 300 continues to operation 320, where it ends.

If, at operation 308, the event service 26 determines that the application program did not terminate its execution normally, the routine 300 continues from operation 308 to operation 314. At decision operation 314, a determination is made as to whether the application program has hung. A hung application is an application that appears to be executing but is not responsive to user input. It should be appreciated that the determination as to whether a program has hung may be made by the operating system or by another program. If the application appears to have hung, the routine 300 continues from operation 314 to operation 316. If the application has not hung, the routine 300 continues from operation 314 to decision operation 322. At decision operation 322, a determination is made as to whether the application program crashed. A program crash refers to the failure of a program to perform correctly, resulting in suspension of operation of the program. If a crash is detected at operation 322, the routine 300 continues to operation 316. If a crash is not detected, the operation 300 continues to operation 320, where it ends. It should be appreciated that in the case of a program crash, the operating system can force a crashed application program to shut down automatically. In the case of a hung program, it is up to the user to notice that the program is hung and to restart the program.

At operation 316, data is written to memory indicating that the session ended in either a crash or a hang, as appropriate. The routine 300 then continues to operation 318, where the length that the application executed before the crash or hang is recorded in memory. The routine 300 then continues from operation 318 to operation 319, where the exception is handled by the operating system. Details regarding aspects of the operation of the exception handler 32 are provided below with respect to FIG. 5. The routine 300 then continues to operation to operation 304 where a new entry is created in the event log 28 for the current application session. The data recording in memory regarding the execution of the program is then stored in the session entry. From operation 319, the routine 300 continues to operation 320, where it ends.

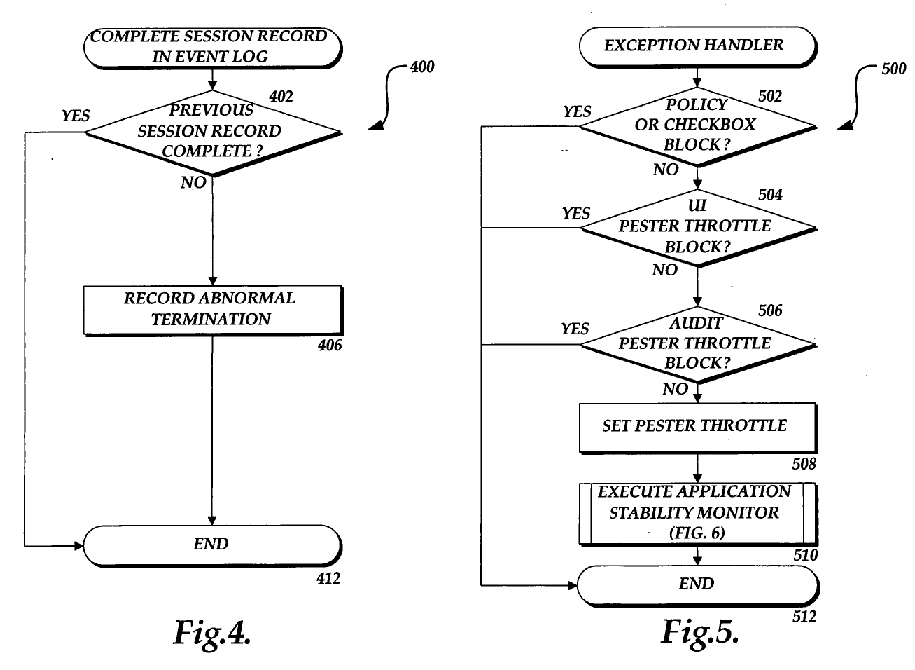

Referring now to FIG. 4, details will be provided for a routine 400 for completing a session entry in the event log. According to embodiments of the system described herein, the routine 400 is executed on the client computer 2 at startup to complete session entries in the event log 28 that may not have been completed. Uncompleted session entries can occur, for instance, if power is removed from the computer 2 while the application is executing, if a crash results in a crash to the operation system 16, or under any other circumstances where the type of termination and session length cannot be written to the event log 28.

The routine 400 begins at operation 402, where a determination is made as to whether the previous session entry is complete. If the session entry is complete, there is no need to perform any further processing on the session entry. Accordingly, the routine 400 continues from operation 402 to operation 412, where it ends, if the session entry is complete. If the session entry is not complete, the routine 400 continues to operation 406, where an indication is made in the session entry that the application program terminated abnormally. The routine 400 then continues to operation 412, where it ends.

Referring now to FIG. 5, additional details regarding the operation of the exception handler 32 will be described. As discussed briefly above, the exception handler 32 is called following the abnormal termination of an application program. It should be appreciated that the exception handler 32 performs many more functions for catching and handling exceptions than those shown in FIG. 5. Only those functions performed by the exception handler relevant to a discussion of the operation of the application stability monitor 24 are shown in FIG. 5 and described herein.

The routine 500 begins at operation 502, where a determination is made as to whether a policy implemented at the client computer 2 or a registry entry indicating that the user does not want to be bothered with reporting prevents the execution of the application stability monitor 24. If so, the routine 500 continues to operation 512, where it ends. If not, the routine 500 continues to operation 504, where a determination is made as to whether a user interface (“UI”) pester throttle prevents the application stability monitor 24 from executing. The UI pester throttle prevents the user from being bothered too frequently with UI relating to application performance monitoring. If the UI pester throttle blocks the execution of the application stability monitor 24, the routine 500 continues to operation 512, where it ends. Otherwise, the routine 500 continues to operation 506, where a determination is made as to whether an audit pester throttle blocks the execution of the application stability monitor 24. The audit pester throttle keeps the application stability monitor 24 from executing too frequently and impacting the performance of the client computer 2. If the audit pester throttle does blocks the execution of the application stability monitor 24, the routine 50 continues to operation 512, where it ends. Otherwise the routine 500 continues from operation 506 to operation 508. Additional details regarding the operation of the UI pester throttle and the audit pester throttle can be found in co-pending U.S. patent application Ser. No. 10/305,215, and entitled “Queued Mode Transmission of Event Reports” which is expressly incorporated herein by reference.

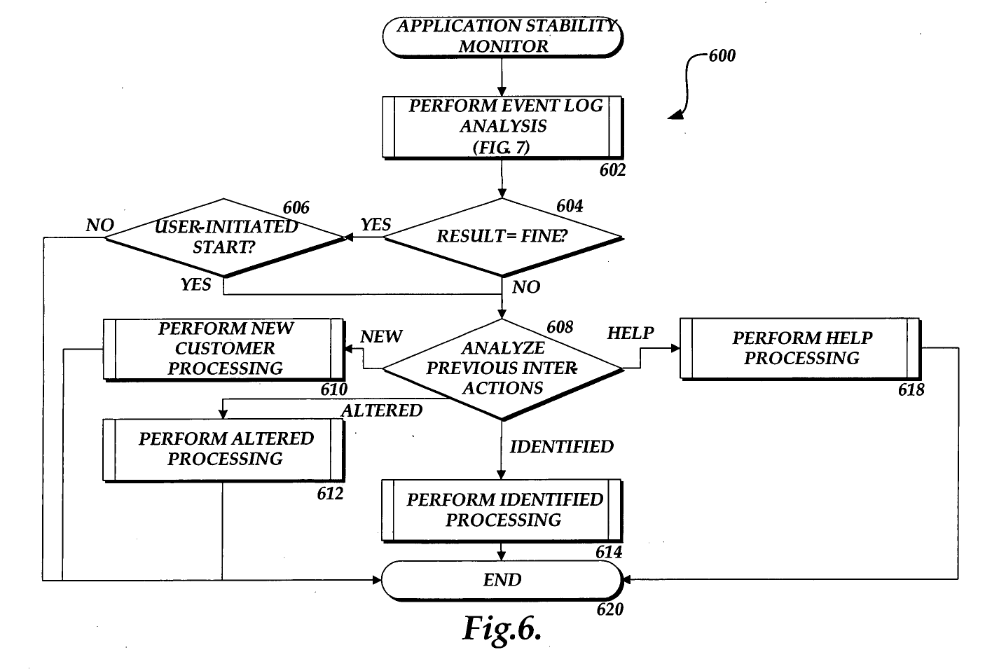

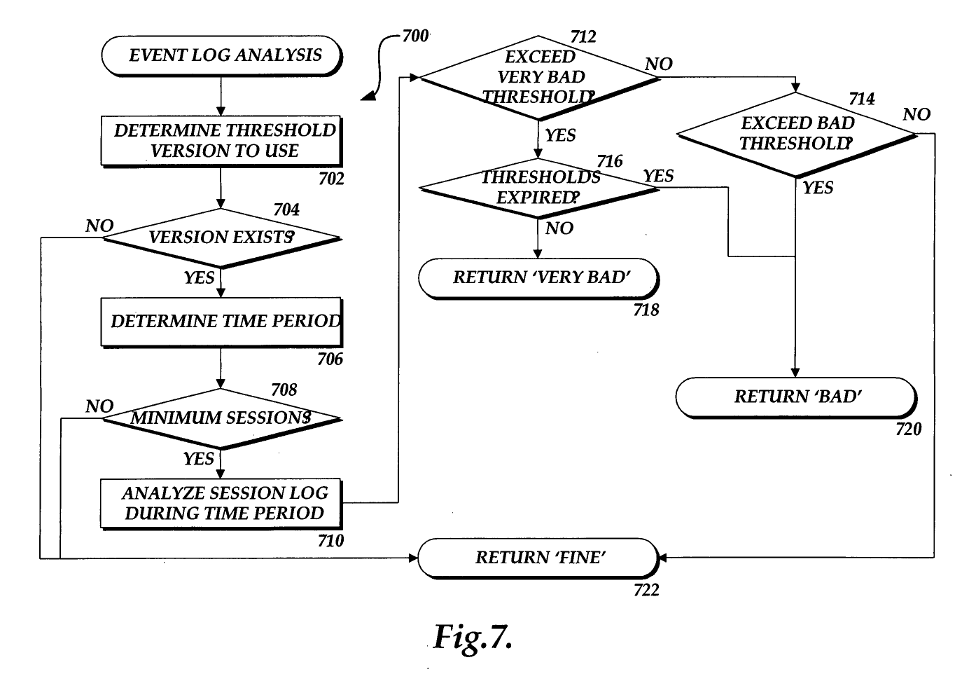

Referring now to FIG. 6, additional details regarding the operation of the application stability monitor 24 will be provided. In particular, the routine 600 will be described for executing the application stability monitor 24. The routine 600 begins at operation 602, where an analysis of the event log 28 is performed. The event log 28 is analyzed to categorize the stability of the application program into a state of stability. As discussed above, according to one embodiment of the system described herein, the stability may be categorized as “fine,” “bad,” or “very bad.” An illustrative routine 700 for performing the event log analysis is described below with respect to FIG. 7.

From operation 602, the routine 600 continues to operation 604, where a determination is made as to whether the stability of the application program was categorized as “fine” by the event log analysis. If the stability of the application program is “fine” the routine 600 continues to operation 606 where a determination is made as to whether the application stability monitor 24 was started manually by a user. If the application stability monitor 24 was not started manually, the routine 600 continues to operation 620, where it ends. If the application stability monitor 24 was started manually, the routine 600 continues from operation 606 to operation 608. This allows a user to interact with the application stability monitor 24 if they start the program manually even where the stability of the program is “fine.”

If, at operation 604, it is determined that the stability of the application program was categorized as “bad” or “very bad” by the event log analysis, the routine 600 continues from operation 604 to operation 608. At operation 608, the routine 600 continues to either operation 610, 612, 614, 616, or 616 based on the users previous interactions with the application stability monitor, as defined by the current value of the diagnostic state registry key described above. If the value of the diagnostic state registry key is “new”, the routine 600 continues to operation 610. This means that the user has no previously utilized the application stability monitor 24. Accordingly, a dialog box may be present to the user for executing the diagnostics 34. Depending upon the result of the diagnostics, the value of the diagnostic state registry key may be set to “help,” “altered,” or “identified.”

If the value of the diagnostics state registry key is “diagnostics altered,” the routine 600 continues from operation 608 to operation 612. This indicates that the diagnostics were executed previously and that changes were made to the configuration of the application program in an attempt to improve its stability. At this point, the user may be directed to free or reduced fee product support for the product. Depending on the chosen course, the value of the diagnostic state registry key may be set to “help,” “altered,” or “identified.”

If the value of the diagnostics state registry key is “diagnostics external,” the routine 600 continues to operation 614. This indicates that the diagnostics 34 were performed previously and a problem was detected other than the application program. In this case, the user is not bothered with any user interface notices.

If the value of the diagnostics state registry key is “help,” the routine 600 continues to operation 618. This indicates that the user has previously been provided with information for reduced fee or free product support. The user may again be given this information. For instance, the user may be directed to a product support web site where product support may be obtained. From operations 610, 612, 614, and 618, the routine 600 continues to operation 620, where it ends.

Turning now to FIG. 7, the routine 700 will be described for analyzing the event log 28. The routine 700 begins at operation 700 where a determination is made as to which threshold version to utilize. As discussed above, the threshold values may be assigned a version number corresponding to versions of an application program on the client computer 2. This allows different thresholds to be assigned to different versions of the same application program. The threshold version to use is determined based on the version of the application program for which an analysis is to be performed.

Once the version number of the application program has been identified, the routine 700 continues to operation 704, where a determination is made as to whether threshold values are present in the remote control file 36 for the version of the application program. If no threshold values exist for the version, the routine 700 continues to operation 722, where a threshold value of “fine” is returned. If, however, the proper threshold values do exist, then the routine 700 continues to operation 706.

At operation 706, the proper time period of entries in the event log that should be utilized in the session analysis is determined. The time period may comprise the period of time between the current time and the last time a repair was applied to the application program. Alternatively, if no repairs have been made, the time period may comprise the time period between the current time and a preferred time window (30 days for instance). In this manner, the universe of log entries that are considered in the analysis may be limited.

From operation 706, the routine 700 continues to operation 708, where a determination is made as to whether a statistically significant minimum number of sessions are present in the event log 28 for the computed time period. If the requisite minimum number of sessions are not present, the routine 700 continues to operation 722, where a threshold value of “fine” is returned. If the requisite minimum number of sessions exists, the routine 700 continues from operation 708 to operation 710.

At operation 710, a number of statistics are generated based upon the contents of the event log 28 for the time period and for the particular application program that describe the stability of the application programs. For instance, a statistic may be generated based on the number of abnormal terminations of the program per number of program executions. Another statistic that may be generated is based on the number of abnormal terminations per number of minutes of program execution. Other types of statistics indicating the stability of the application program may also be generated based on the contents of the event log 28 during the time period. It should be appreciated that certain statistics may be generated for individual applications and that other statistics may be generated for groups of applications, such as application suites.

Once the statistics have been generated, the statistics are compared to the threshold values contained in the remote control file 36. Based on the comparison, the stability of the application program may be categorized as “fine,” “bad,” or “very bad.” Once the stability of the application program has been categorized, the routine 700 continues to operation 712, where a determination is made as to whether the stability of the program has been categorized as very bad. If the stability has not been categorized as very bad, the routine 700 continues to operation 714 where a determination is made as to whether the stability has been categorized as bad. If the stability has been categorized as bad, the routine 700 continues to operation 700 where the “bad” threshold is returned. If the stability has not been categorized as “bad,” the routine continues to operation 722, where “fine” is returned.

If, at operation 712, it is determined that the threshold has been categorized as “very bad”, the routine 700 continues to operation 716. At operation 716, a determination is made as to whether the threshold values have expired. As discussed briefly above, the thresholds may include expiration dates. If the threshold values have expired, the routine 700 continues to operation 720 where “bad” is returned. Otherwise the routine 700 continues to operation 718, where “very bad” is returned.

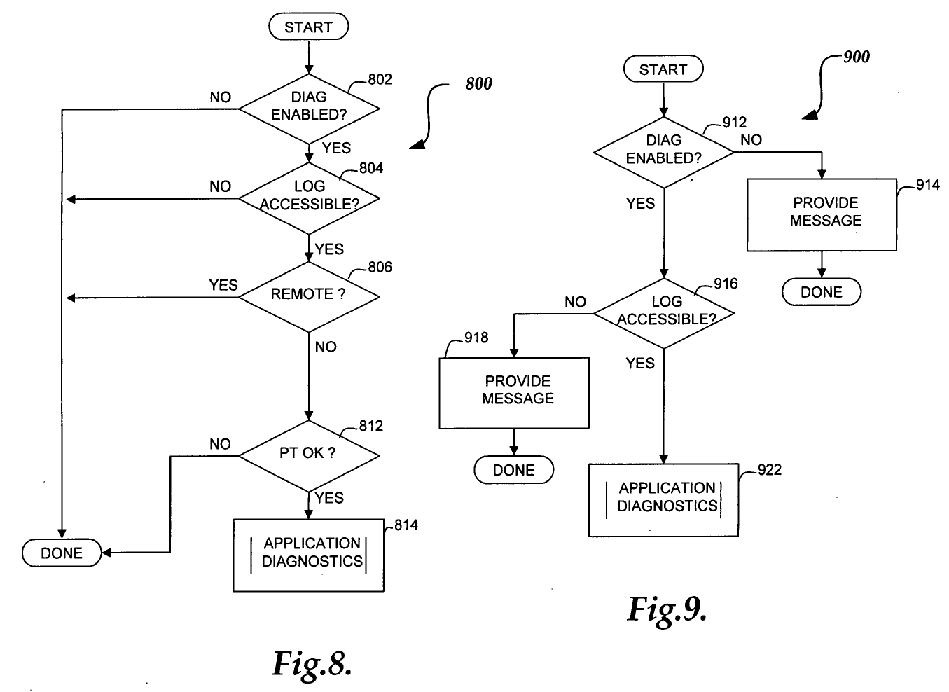

Referring to FIG. 8, a flow chart 800 illustrates an alternative embodiment of the exception handler illustrated in FIG. 5 and discussed above. Processing begins at a first step 802 where it is determined if diagnostics for the application are enabled. In an embodiment herein, it is possible to disable certain types of application diagnostics, including diagnostics that run in connection with the application diagnostic system described herein. Accordingly, if it is determined at the test step 802 that application diagnostics are not enabled, then processing is complete.

If it is determined at the test step 802 that diagnostics are enabled, then control passes from the test step 802 to a test step 804 where it is determined if a diagnostic data log is accessible. In an embodiment herein, the application diagnostics use data logging to keep track of the state of the application diagnostics and to record certain values. In some instances, logging of data may not be possible (e.g., when a user does not have sufficient rights to provide data to the log file). In instances where logging is either not enabled or not possible (i.e., log data is not accessible), then diagnostics will not be run and processing ends following the step 804.

If the log data is accessible, then control passes from the test step 804 to a test step 806 which determines if the particular application that is running is being run from a remote location. In an embodiment herein, applications may be run remotely using, for example, remote terminal or terminal server mode. In such cases, the application may be running on a first computer by a user at a second computer. If it is determined at the test step 806 that the application which caused the exception handler to be called is running remotely, then processing ends following the step 806. In an embodiment described herein, diagnostic processing is not provided for users running remotely.

If it is determined at the test step 806 that the application is not running remotely, then control passes to a test step ˜812 which tests the UI pester throttle (PT). The pester throttle is a variable that is provided to prevent excessive invocation of the diagnostics. In some embodiments, it is desirable to be able to prevent the user from seeing the user interface for the diagnostics too often. This is accomplished by using the pester throttle to prevent excessive access by invoking or not invoking the diagnostics according to the pester throttle. The pester throttle mechanism is described in more detail elsewhere herein.

If it is determined at the test step 812 that the pester throttle has an appropriate value to allow diagnostics to proceed, then control passes from the test step 812 to a step 814 where the application diagnostics are performed. The step 814 is described in more detail elsewhere herein. Note that if it is determined at the test step 812 that the pester throttle prevents running of the diagnostics, then processing is complete following the test step 812.

In some instances, it may be desirable to manually invoke the application diagnostics without waiting for the exception handler to execute (i.e., without waiting for an application program to crash). Thus, in some embodiments, it is possible to manually invoke the application diagnostics.

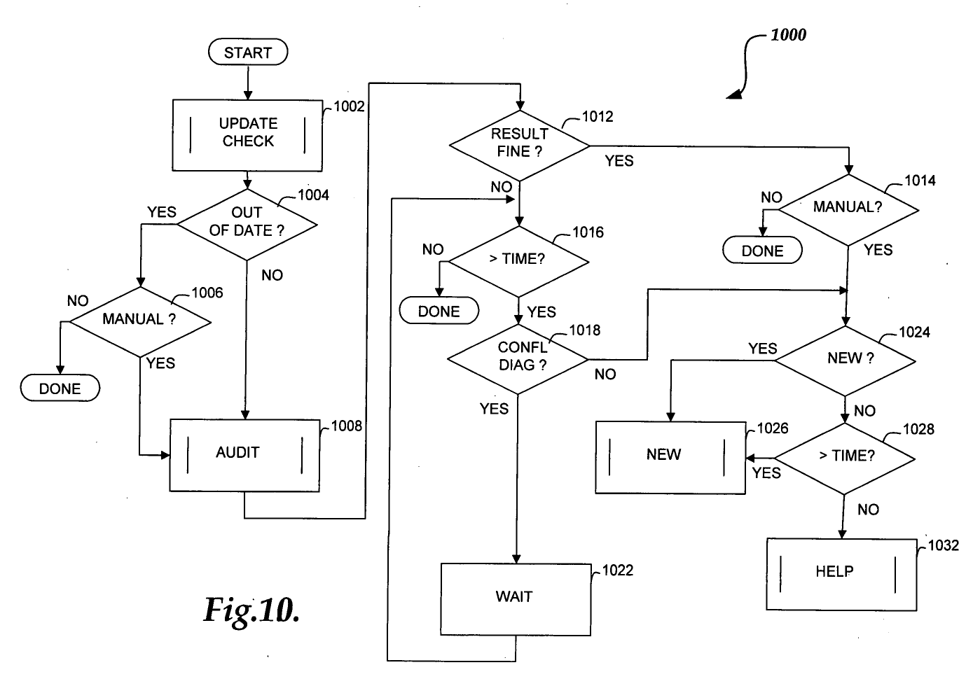

Referring to FIG. 9, a flow chart 900 illustrates steps performed in connection with manually invoking the application diagnostics. Processing begins a first test step 912 where it is determined if application diagnostics have been enabled. The test step 912 is like the test at the step 802 in the flow chart 800 discussed above in connection with FIG. 8. If it is determined at the test step 912 that diagnostics are not enabled, then control passes from the test step 912 to a step 914, where the user is provided with an appropriate message indicating that it is not possible to run application diagnostics and why. Following the step 914, processing is complete.

If it is determined at the test step 912 that application diagnostics are enabled, then control passes from the step 912 to a test step 916 where it is determined if the event log is accessible. The test step 916 is like the test step 804 of the flow chart 800 of FIG. 8. If it is determined at the test step 916 that the event log is not accessible, then control transfers from the test step 916 to a step 918 where the user is provided with an appropriate message indicating that it is not possible to run application diagnostics and why. Following the step 918, processing is complete.

If it is determined at the test step 916 that the diagnostic event log is accessible, then control transfers from the test step 916 to a step 922 where the application diagnostics are performed. The step 922 is like the step 814 of the flow chart 800 of FIG. 8. The step 922 is discussed in more detail hereinafter.

Referring to FIG. 10, a flow chart 1000 illustrates in more detail application diagnostics discussed above in connection with the step 814 of the flow chart 800 of FIG. 8 and the step 922 of the flow chart 900 of FIG. 9. Processing begins at a first step 1002 where an update check is performed to determine if the user has the latest version and/or patches of the application. The update check performed at the step 1002 is discussed in more detail hereinafter.

Following the step 1002 is a test step 1004 which determines if the application is out of date (e.g., the user is not running the latest version and/or the user has not applied the latest patches). In some instances, it is possible that the application may be out of date even though a user was previously prompted to update the application. For example, it is possible that a user is not authorized to make changes to the application and/or can not get access to the latest versions/patches for the application. It is also possible that a user simply chose not to perform update processing.

If it is determined at the test step 1004, that the application software is still out of date, then control transfers from the test step 1004 to a step 1006 where it is determined if the application diagnostic system was entered via a manual start (e.g., FIG. 9). If not, then processing is complete. Otherwise, control transfers from the test step 1006 to a step 1008 where audit processing is performed to determine if follow on processing (described elsewhere herein) is appropriate. Details related to the processing performed at the step 1008 are provided elsewhere herein. Note that the step 1008 follows the step 1004 if it is determined at the step 1004 that the application software is not out of date.

Following the step 1008 is a test step 1012 which determines if the result returned by the audit processing at the step 1008 indicates that the application is “fine”. In an embodiment herein, the processing performed at the audit step 1008 returns a result that is one of: “fine”, “bad”, or “very bad” indicating the state of the application. For example, an application that crashes repeatedly may cause the audit step 1008 to return a result of “very bad” whereas an application that rarely or never crashes and runs to completion each time may cause the audit step 1008 to return a result of “fine”.

If it is determined at the test step 1012 that the audit processing at the step 1008 returns a result of fine, then control transfers from the test step 1012 to a test step 1014 which determines if the user had entered the application diagnostic system via a manual start. If not, (i.e. diagnostics were entered automatically), then processing is complete.

If it is determined at the test step 1012 that the audit processing at the step 1008 did not return a result of fine, then control transfers from the test step 1012 to a test step 1016 which determines if more than a given amount of time (e.g., twenty four hours) has passed since the application diagnostics were started. If application diagnostics have been running for more than the given amount of time then something is wrong and processing is terminated from the step 1016. Otherwise, control transfers from the test step 1016 to a test step 1018 which determines if conflicting diagnostics are being run. Conflicting diagnostics include any diagnostic process that could possibly interfere with or detract from the user's experience with the diagnostic system described herein (e.g., other diagnostic processes that provide user messages). If it is determined at the step 1018 that conflicting diagnostics are being run, then control transfers from the test step 1018 to a step 1022 where a wait process is performed. Following the step 1022, control transfers back to the test step 1016 to again determine if more than the given amount of time has passed since the application diagnostics described herein were started.

In an alternative embodiment, it is possible to perform processing that waits for either the given amount of time to pass (e.g., twenty four hours) or waits for the alternative diagnostics to end and, when either occurs, control transfers to the step 1022.

If it is determined at the test step 1018 that conflicting diagnostics are not running, or if it is determined at the test step 1014 that the user entered diagnostics via manual start, then control transfers to a test step 1024 where it is determined if the user is in a “new” state with respect to the application diagnostic system. In an embodiment herein, a new state refers to a situation where the user has never run the application diagnostic system described herein or more than three months have passed since the user has run the application diagnostic system. If it is determined at the test step 1024 that the user is in a new state, then control transfers from the test step 1024 to a step 1026 where new user state processing is performed. The new user state processing performed at the step 1026 is described in more detail elsewhere herein.

If it is determined at the test step 1024 that the user is not in a new user state with respect to the application diagnostic system, then control transfers from the test step 1024 to a test step 1028 to determine if more than a given amount of time (e.g., three months) has passed since the user last used the application diagnostic system. If so, then the user is in a new user state and control transfers from the test step 1028 to the step 1026 where new user state processing is performed. Otherwise, if more than the given amount of time has not passed since the user last used the application diagnostic system described herein, then control transfers from the test step 1028 to a step 1032 where user help processing is performed. User help processing is described in more detail elsewhere herein.

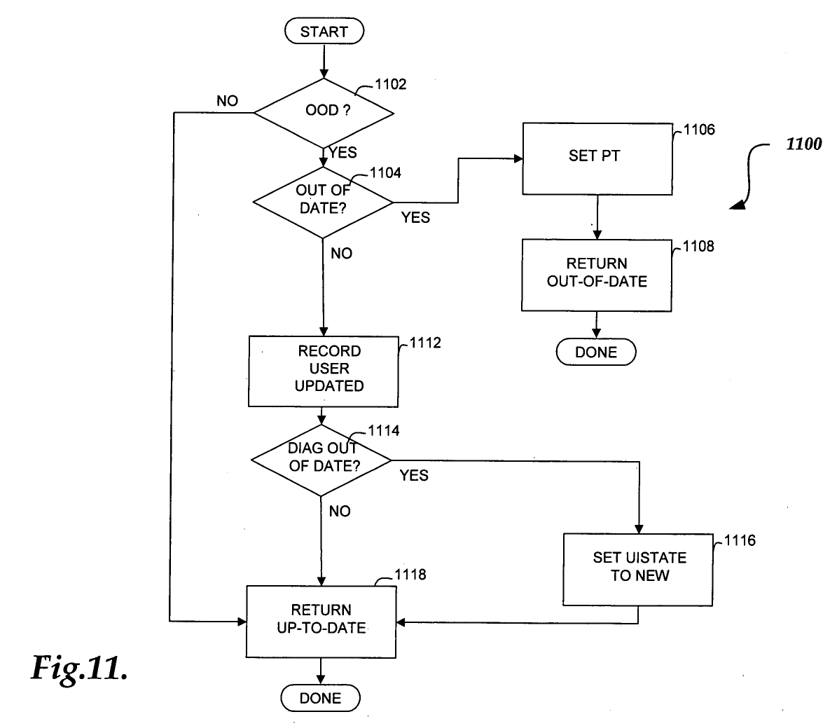

Referring to FIG. 11, a flow chart 1100 illustrates steps performed in connection with the update check step 1002 of the flow chart 1000 of FIG. 10, discussed above. Processing begins at a first step 1102 where it is determined if the current version of the software is out-of-date by, for example, checking the status of an out-of-date variable (OOD VAR) that may be set in connection with running update diagnostics (described elsewhere herein) when the software is found to be out-of-date (not the latest version or in need of patches) and the update diagnostics attempts to update the software. Of course, other appropriate techniques may be used to track the out-of-date state.

If it is determined at the test step 1102 that the software is out-of-date, then control transfers from the step 1102 to a test step 1104 to determine if the application software is actually out-of-date (still out-of-date). In some cases, it is possible for the update diagnostics to find that the software is out-of-date (and to have, for example, set the out-of-date variable) but the user does not subsequently update the software. For example, a user may not have appropriate privileges to update/patch software and/or may not have access to the data needed to update/patch the application and/or may simply elect not to update his or her software. Thus, the test at the step 1104 may compare the current version of the application with the known latest version of application.

If it is determined at the test step 1104 that the application software is out-of-date, then control transfers from the test step 1104 to a step 1106 where the pester throttle (PT) is set to a given amount of time (e.g., twelve weeks). As discussed elsewhere herein, the PT is used to control how often a user is automatically presented with the application diagnostic system. If the PT is set to twelve weeks at the step 1106, the user is essentially placed in a new user state provided that twelve weeks (approximately three months) is the threshold used at the step 1028, discussed above. Following the step 1106 is a step 1108 where an out-of-date indicator is returned. Following the step 1108, processing is complete. Note that returning the out-of-date indicator at the step 1108 controls the result of the test 1104 of the flow chart 1000 of FIG. 10, as discussed above.

If it is determined at the test step 1104 that the application software is not out-of-date (i.e., the application software has been updated successfully), then control transfers from the test step 1104 to a step 1112 where indicators are set to reflect the fact that the user's software has recently been updated. The indicators set at the step 1112 may be used for follow-on processing.

Following the step 1112 is a test step 1114 where it is determined if the application diagnostic results (discussed elsewhere herein) are out of date. The application diagnostic results may be out of date for any number of reasons, such as the recent software update rendering the diagnostic results moot and/or a significant amout of time having passed since diagnostics having been run. If it is determined at the step 1114 that the application diagnostic results are out of date, then control passes from the step 1114 to a step 1116 where the user interface state is set to “new”. As discussed elsewhere herein, different processing may be performed depending upon whether a user is in a new state with respect to the application diagnostic system described herein. See, for example, the discussion above with respect to the step 1024 of the flow chart 1000 of FIG. 10. Following the step 1116 is a step 1118 where the update check routine returns an indicator indicating that the application software is up-to-date. This indicator is used at the test step 1004 of the flow chart 1000 of FIG. 10, discussed above. Note that the step 1118 may also be reached from the test step 1102 if the out-of-date (OOD) variable is not set. The step 1118 may also be reached from the test step 1114 if it is determined that the application diagnostic data is not out of date.

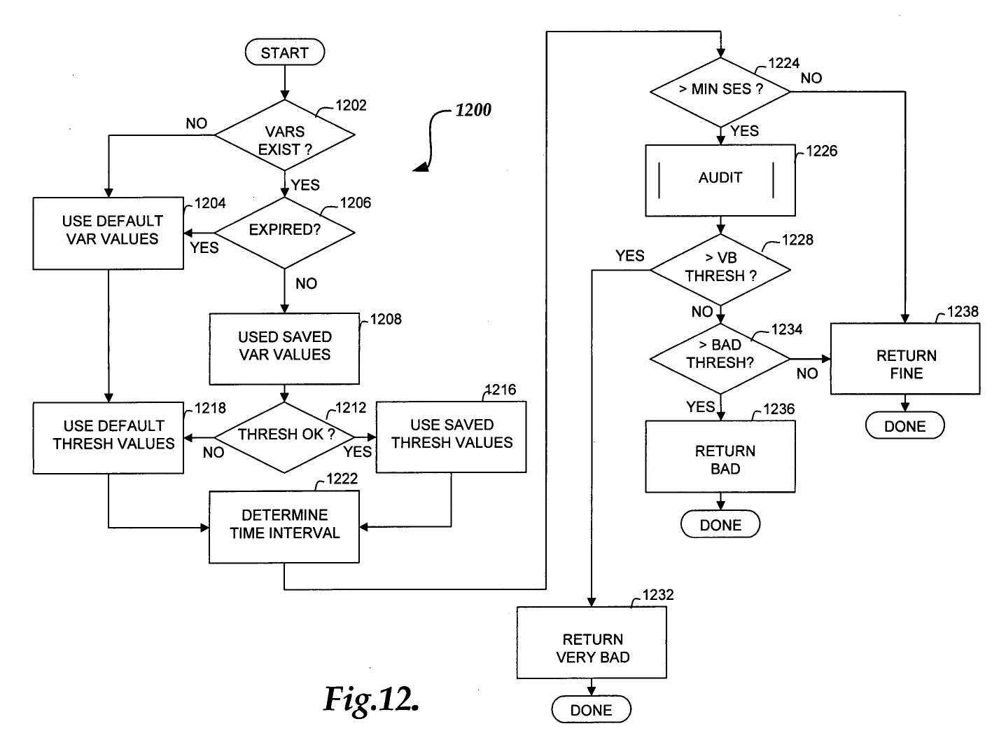

Referring to FIG. 12, a flow chart 1200 illustrates in more detail the audit step 1008 of the flow chart 1000 of FIG. 10. Processing begins at a first test step 1202 which determines if the audit variables exist. The audit variables are used to keep track of states, previous results of diagnostics, etc. for the application diagnostic system. In some cases, a user may opt to periodically download appropriate audit variables and thresholds. In some instances (e.g., user has opted not to receive periodic downloads), no audit variables may exist. If it is determined at the test step 1202 that no audit variables exist, then control transfers from the test step 1202 to a step 1204 where default audit variable values are used. The default audit variable values may include initial values, etc.

If it is determined at the test step 1202 that audit variables exist, then control transfers from the test step 1202 to a test step 1206 where it is determined if the audit variables have expired. Audit variables may expire after a certain amount of time (e.g., twelve weeks) or under other conditions, such as a new version of an application being installed. If it is determined at the step 1206 that the audit variables have expired, then control transfers from the test step 1206 to the step 1204, discussed above, where default variable values are used. Otherwise, control transfers from the test step 1206 to a step 1208 where the downloaded audit variable values are used. Note that, generally, it may be possible to use more aggressive thresholds (i.e., thresholds more likely to trigger an event) when downloaded thresholds are used since downloaded thresholds may be modified while default thresholds may persist for the life of an application.

Following the step 1208 is a test step 1212 where it is determined if appropriate threshold values are present. An embodiment of the system described herein, the audit variables, diagnostic tests, etc. are compared with threshold values which may or may not change depending on various states. Thus, the thresholds may be dynamic or they may be hard coded default values. In any case, the test at the step 1212 determines if appropriate threshold values are available. Threshold values may not be appropriate under a number of conditions, including there not being thresholds for the particular version of software being tested. If it is determined at the step 1212 that the threshold values are not appropriate, then control transfers from the test step 1212 to a step 1216 where default threshold values are used. Note that the step 1216 also follows the step 1204 when default variable values are used. Thus, in instances where there are no audit variables available or the audit variables have expired and the default variable values are used at the step 1204, default threshold values are also used. If it is determined at the test step 1212 that appropriate threshold values are available, then control transfers from the test step 1212 to a step 1218 where the saved threshold values are used.

Following either the step 1216 or the step 1218 is a step 1222 where a time interval is calculated. At the step 1222, a time interval is calculated to determine the amount of time over which the number of diagnostic sessions will be counted. In an embodiment herein, the time interval calculated at the step 1222 is determined by subtracting, from the current time, either the time that the last fix (e.g., update) occurred or a maximum time amount (e.g., 12 weeks) if the maximum time amount is less than the time since the last fix or if there has been no last fix.

Following the step 1222 is a test step 1224 which determines if the number of diagnostic sessions during the time interval calculated at the step 1222 is greater than a minimum number of sessions (e.g., eight sessions). In an embodiment herein, the diagnostic system is not run unless at least a minimum number of sessions have occurred during the time interval calculated at the step 1222. If it is determined at the test step 1224 that more than the minimum number of sessions have occurred, then control transfers from the test step 1224 to a step 1226 where audit tests are performed. The processing performed at the step 1226 is discussed above in connection with FIG. 7. Following step 1226 is a test step 1228 which determines if the results of the audit tests exceed the threshold for very bad. If so, then control transfers from the test step 1228 to a step 1232 where the audit processing illustrated by the flow chart 1200 returns very bad. Following the step 1232, processing is complete.

If it is determined at the test step 1228 that the results of the audit test performed at the step 1226 do not exceed the very bad threshold, then control transfers from the test step 1228 to a test step 1234 which determines if the result of the audit tests performed at the step 1226 exceed a bad threshold. If so, then control transfers from the test step 1234 to a step 1236 where the audit processing returns a bad indicator. Following the step 1236, processing is complete. On the other hand, if it is determined at the test step 1234 that the results of the audit tests performed at the step 1226 do not exceed the bad threshold, then control transfers from the test step 1234 to a step 1238 where a fine indicator is returned. Following the step 1238, processing is complete. Note that the step 1238, where a fine indicator is returned, is also reached from the test step 1224 if it is determined that the number of diagnostic sessions does not exceed the minimum sessions requirement. Thus, where the minimum number of sessions during the time interval calculated at the step 1222 does not exceed the minimum number of sessions, a fine indicator is returned from the audit processing irrespective of the diagnostic state of the application.

Any set of quantification values, thresholds, etc. may be used which appropriately differentiate between applications that are in a relatively good (stable) state and applications that need special diagnostic attention as described herein. The particular threshold values, quantification of the diagnostic tests, the number of different levels of results, etc. may be set to any appropriate values that provide worthwhile results according to the description herein.

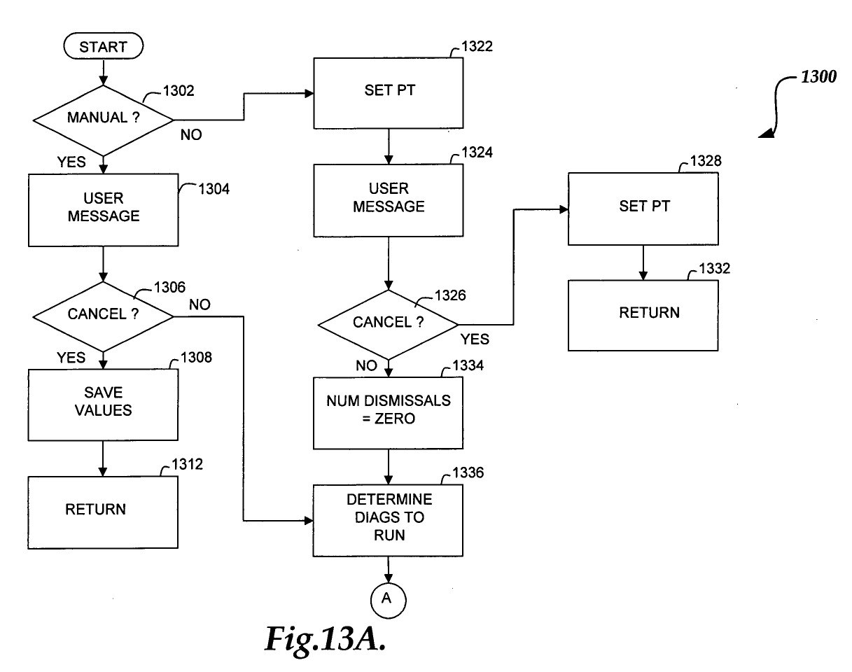

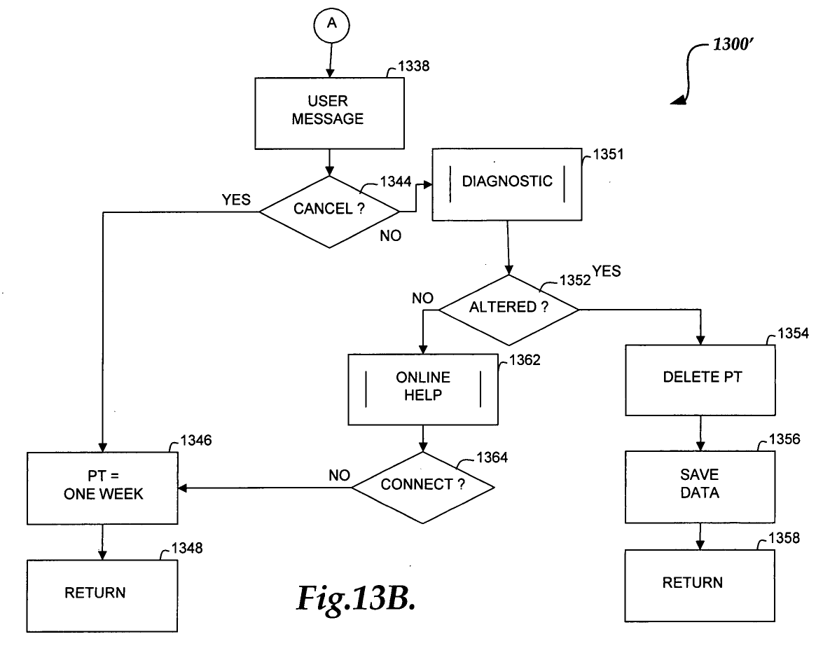

Referring to FIGS. 13A and 13B, a flow chart 1300, 1300′ illustrates steps performed in connection with the step 1026 (New processing) in the flow chart 1000 of FIG. 10. Processing begins at a first step 1302 where it is determined if the user has entered the application diagnostic system manually (as illustrated by FIG. 9) or automatically (as illustrated by FIG. 8). If it is determined at the test step 1302 that the user has entered the diagnostic system manually, then control transfers from the test step 1302 to a step 1304 where the user is provided with an introductory message inviting the user to continue with the application diagnostic system.

Following the step 1304 is a test step 1306 where it is determined if the user chooses not to continue with the system by, for example, pressing a cancel button. If so (i.e., if the user chooses not to continue), then control transfers from the test step 1306 to a step 1308 where the user saves state values associated with the application diagnostic system. The state values may include, for example, an indication that the user had manually invoked the application diagnostic system. Following the step 1308 is a step 1312 where the user returns to whatever state or application the user was when the user invoked the application diagnostic system.

If it is determined at the test step 1302 that a user has entered the application diagnostic system automatically, then control transfers from the step 1302 to a step 1322 where the pester throttle (discussed elsewhere herein) is set to a given amount of time (e.g., one week). Following the step 1322 is a step 1324 where the user is provided with an introductory message inviting the user to continue with the application diagnostic system. Following the step 1324 is a test step 1326 where it is determined if the user chooses not to continue with the system by, for example, selecting a cancel option. If the user chooses not to continue, then control transfers from the test step 1326 to a step 1328 where the pester throttle is set according to the number of previous times the user has dismissed (canceled) automatic entry of the application diagnostic system. In an embodiment herein, the more often a user chooses to dismiss the application diagnostic system, the higher the pester throttle will be set in order to increase the amount of time before the next automatic entry of the application diagnostic system. Following the step 1328 is a step 1332 where the user returns to whatever state or application the user was when the application diagnostic system was invoked.

If it is determined at the test step 1326 that the user does not cancel the application diagnostic system, then control transfers from the test step 1326 to a step 1334 where a variable that keeps track of the number of times the user has dismissed entry into the application diagnostic system is set equal to zero. The variable set at the step 1334 is used to set the pester throttle at the step 1328. Following the step 1334 is a step 1336 where it is determined which particular diagnostics are to be run. Note that the step 1336 is also reached if it is determined at the test step 1306 that the user has not decided to cancel entry into the application diagnostic system. At the step 1336, the user it may be presented with options for choosing particular diagnostics to be run. In other embodiments, the user may be required to run all diagnostics or, alternatively, the choice of which diagnostics to run are made by a system administrator and may not be controllable by the user.

Following the step 1336 is a step 1338 (on the flowchart 1400′ of FIG. 13B) where the user is provided with a message indicating that diagnostics are being run. In an embodiment herein, the message provided at the step 1338 may include some type of progress indicator, such as a progress bar. Following the step 1338 is a test step 1344 where it is determined if the user has decided to cancel diagnostics prior to completion. If so, then control transfers from the step 1344 to a step 1346 where the pester throttle is set to one week. Following the step 1346 is a step 1348 where the user returns to whatever state or application the user was when the application diagnostic system was invoked.

If it is determined at the step 1344 that the user has not canceled out of diagnostics, then control transfers from the test step 1344 to a step 1351, where diagnostic tests are performed. Performance of diagnostic tests at the step 1351 is discussed in more detail elsewhere herein. Following the step 1351 is a test step 1352 where it is determined if the results of any of the diagnostics that were run at the step 1351 indicate that the application and/or application set up data has been altered. As discussed elsewhere herein, one of the possible results of running diagnostics is that one or more of the diagnostics may update the application and/or application set up data with the latest version and/or patches. If it is determined at the test step 1352 that the application and/or application set up data has been altered, then control transfers from the test step 1352 to a step 1354 where the pester throttle variable is deleted. Deleting the pester throttle variable at the step 1354 allows the application diagnostic system to be entered upon the next occurrence of an appropriate event (e.g., a system crash). Following the step 1354 is a step 1356 where state information for the application diagnostic system, variables, etc., is saved. Following the step 1356 is a step 1358 where the user returns to whatever state or application the user was when the application diagnostic system was invoked.

If it is determined at the test step 1352 that the results of the diagnostics do not indicate that either the application or the application set up data has been altered, then control transfers from the test step 1352 to a step 1362 where additional online help is offered to a user. Offering additional help at the step 1362 is described in more detail elsewhere herein. Following the step 1362 is a test step 1364 where it is determined if the additional online help offered at the step 1362 could not complete (or start) because the user had difficulty connecting (i.e., via the Internet). If so, then control transfers from the step 1364 to the step 1346, discussed above.

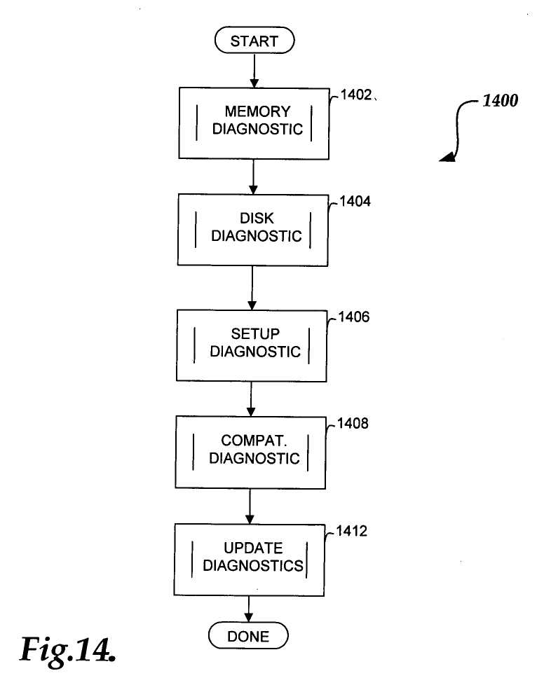

Referring to FIG. 14, a flow chart 1400 illustrates in more detail the diagnostic test processing performed at the step 1226 of the flow chart 1200 of FIG. 12. Processing begins at a first step 1402 where memory diagnostics are performed. Following step 1402 is a step 1404 where disk diagnostics are performed. Following the step 1404 is a step 1406 where set up diagnostics are performed to determine if the particular application has been set up properly (i.e., if setup data files associated with the application are properly configured). Following step 1406 is a step 1408 where compatibility diagnostics are performed. Following the step 1408 is a step 1412 where update diagnostics are performed to determine if the user is running the most recent version of the application and/or any appropriate patches. Following step 1412, processing is complete. Of course, the diagnostic tests illustrated by the flow chart 1400 may be performed in any order.

In an embodiment herein, each of the diagnostic tests performed in connection with the steps of the flow chart 1400 may return one of three results: A first possible result indicating that the application and/or application configuration data has been altered, a second possible result indicating that the application and/or application configuration information has not been altered, or a third possible result indicating that the application and/or application configuration data has not been altered but a possible source of veneer has been identified. The altered result may be provided by a diagnostic test when a diagnostic test alters the application and/or application configuration data. For example, the update diagnostic performed at the step 1412 may update the application to a more current version and/or may provide patches for the application. In such a case, the update diagnostic performed at the step 1412 may return a result indicating that the application has been altered. Similarly, the set up diagnostic performed at the step 1406 may alter application set up data and return a result indicating that the set up data/application has been altered. In some embodiments, only the setup diagnostic step 1306 is capable of performing alterations.

The identified result indicates that a possible source of error has been identified but that nothing has been changed. Nothing may be changed for any of a number of reasons. For example, a user may make a selection not to alter the applications and/or application set up data or the user may not have sufficient permissions to make the alteration. Other possible reasons include the user not having online access to data/information needed to make the alteration.

The unaltered result from a diagnostic test indicates that neither the application nor the application set up data has been altered and, in addition, no potential source of problems experienced by a user have been identified.

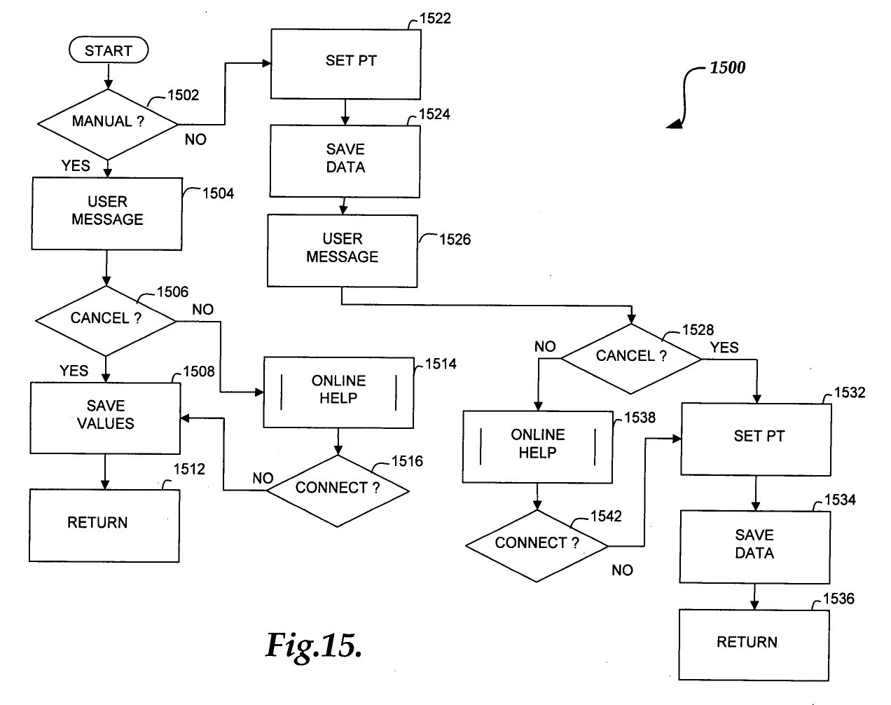

Referring to FIG. 15, a flow chart 1500 illustrates in more detail processing performed at the step 1032 (help) of the flow chart 1000 of FIG. 10. Processing begins at a first step 1502 where it is determined if the user has entered the application diagnostic system by a manual start (e.g., according to the flow chart 900 of FIG. 9) rather than and automatically (e.g., according to the flow chart 800 of FIG. 8). If it is determined at the test step 1502 that the user has entered the application diagnostic system manually, then control transfers from the test step 1502 to a step 1504 where an introductory message is provided to the user. Following the step 1504 is a test step 1506 where it is determined if the user has decided to exit the application diagnostic system by canceling. If so, then control transfers from the test step 1506 to a step 1508 where data associated with the application diagnostic system (e.g., state data) is saved. Following the step 1508 is a step 1512 where the user returns to whatever state or application the user was when the application diagnostic system was invoked.

If it is determined at the test step 1506 that the user is not canceling out of the application diagnostic system, then control transfers from the test step 1506 to a step 1514 where additional online help processing is performed. Performing additional online help processing at the step 1514 is discussed in more detail hereinafter. Following the step 1514 is a test step 1516 where it is determined if the additional online help processing at the step 1514 exited because the user had difficulty connecting (i.e., via the Internet). If so, then control transfers from the step 1516 to the step 1508, discussed above.

If it is determined at the test step 1502 that a user has entered the application diagnostic system automatically, then control transfers from the step 1502 to a step 1522 where the pester throttle (discussed elsewhere herein) is set to a given amount of time (e.g., one week). Following the step 1522 is a step 1524 where data associated with the application diagnostic system (e.g., state data) is saved. Following the step 1524 is a step 1526 where the user is provided with an introductory message inviting the user to continue with the application diagnostic system. Following the step 1526 is a test step 1528 where it is determined if the user chooses not to continue with the system by, for example pressing a cancel button. If the user chooses not to continue, then control transfers from the test step 1528 to a step 1532 where the pester throttle is set to a given amount of time (e.g., one week). Following the step 1532 is a step 1534 where data associated with the application diagnostic system (e.g., state data) is saved. Following the step 1534 is a step 1536 where the user returns to whatever state or application the user was when the application diagnostic system was invoked.

If it is determined at the test step 1528 that the user has not decided to cancel out of the application diagnostic system, then control transfers from the test step 1528 to a step 1538 where additional online help processing is performed. Performing additional online help processing at the step 1538 is described in more detail elsewhere herein. Following the step 1538 is a test step 1542 where it is determined if the additional online help processing at the step 1538 exited because the user had difficulty connecting (i.e., via the Internet). If so, then control transfers from the step 1538 to the step 1532, discussed above.

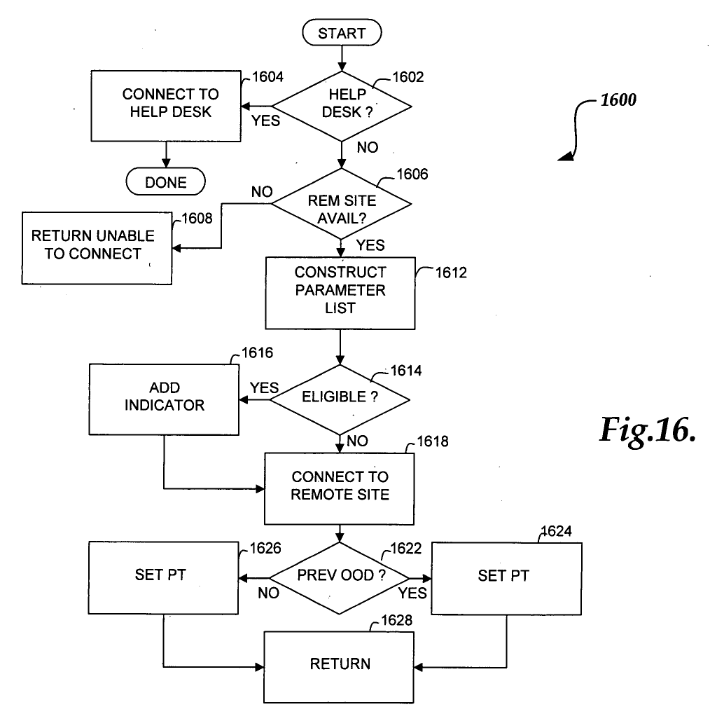

Referring to FIG. 16, a flow chart 1600 shows in more detail processing performed in connection with the step 1362 of the flow chart 1300, 1300′ of FIGS. 13A and 13B, and the steps 1514, 1538 of the flow chart 1500 of FIG. 15. The flow chart 1600 represents connecting from the client computer 2 to a remote site such as one or both of the error reporting server computer 10 and/or the product supports server 6. Connection may be via the Internet 8 as discussed above in connection with FIG. 1.

Processing begins at a first step 1602 where it is determined if help desk functionality is available. In some cases (e.g., within a large corporation), there may be localized help desk functionality for users experiencing problems with applications. In those instances, control transfers from the test step 1602 to a step 1604 where the user is connected to his or her localized help desk. Following connection to the localized help desk, processing is complete because, in an embodiment herein, a user may not be given access to the diagnostic system described herein when a localized help desk is available. If it is determined at the test step 1602 that help desk functionality is not available, then control transfers from the test step 1602 to a test step 1606 where it is determined if a remote connection (e.g., to the error reporting server computer 10 and/or the product supports server 6) is available. The remote connection is used to process the diagnostics and provide support as discussed herein. If it is determined at the test step 1608 that the remote connection is not available, then control transfers from the test step 1606 to a step 1608 where an indicator is set to indicate that the system is unable to connect. As discussed above in connection with FIGS. 13A, 13B and 15, if online diagnostics indicate that the user was unable to connect, the user is returned to wherever the user was when the application diagnostic system was invoked.

In some embodiments, if a user is unable to connect, additional processing may be performed, including having the user be pointed at a local file which gives rudimentary, general information about next steps to take. In such a case, the user may then be encouraged to trigger diagnostics to run next time the user is connected to the Internet. In this situation, the user may be provided with online help without having to rerun diagnostics. If the user is connected to the Internet the next time the user crashes after the pester throttle expires, more help may be automatically offered.

If a remote connection is available, then control transfers from the test step 1606 to a step 1612 where a parameter list for the additional online help is constructed. The parameter list constructed at the step 1612 may include data indicating the results of the diagnostic tests (run locally), results of the audit tests, and other state data related to the application diagnostic system.

Following the step 1612 is a test step 1614 which determines if the user is eligible for support (e.g., eligible for free support). As discussed elsewhere herein, for some embodiments, a user experiencing difficulties may be provided with free support from a product support specialist or other appropriate person (e.g., an application developer). In an embodiment herein, the test at the step 1614 determines if the user is a corporate user (having a corporate help desk and thus ineligible for free support), if the user is using an evaluation version of the application (and thus ineligible for free support), etc. The test or tests performed at the step 1614 may be any tests that are commercially feasible and appropriate for a given situation. In an embodiment herein, the tests at the step 1614 may include evaluation of the results of the diagnostic tests and the audit tests, described above.

If it is determined at the test step 1614 that the user is eligible for free support, then control transfers from the test step 1614 to a step 1616 where an indicator is attached to the parameter list (constructed at the step 1612) to indicate that the user is eligible for free support. Following the step 1616, or following the step 1614 if the user is not eligible for free support, is a step 1618 where the user is connected to the remote site (e.g., the error reporting server computer 10 and/or the product supports server 6). The processing performed at the remote site is discussed in more detail elsewhere herein. Following the step 1618 is a test step 1622 which determines if the previous result of running the diagnostics indicated that the application and/or application setup data was out of date (OOD). If so, then control transfers from the test step 1622 to a step 1624 where the pester throttle is set to a given time (e.g., one week). Otherwise, control transfers from the test step 1622 to a step 1626 where the pester throttle is set to a different given time longer than the time used at the step 1624 (e.g., set to twelve weeks). Following the step 1624 or the step 1626 is a step 1628 where the user returns to whatever state or application the user was when the application diagnostic system was invoked.

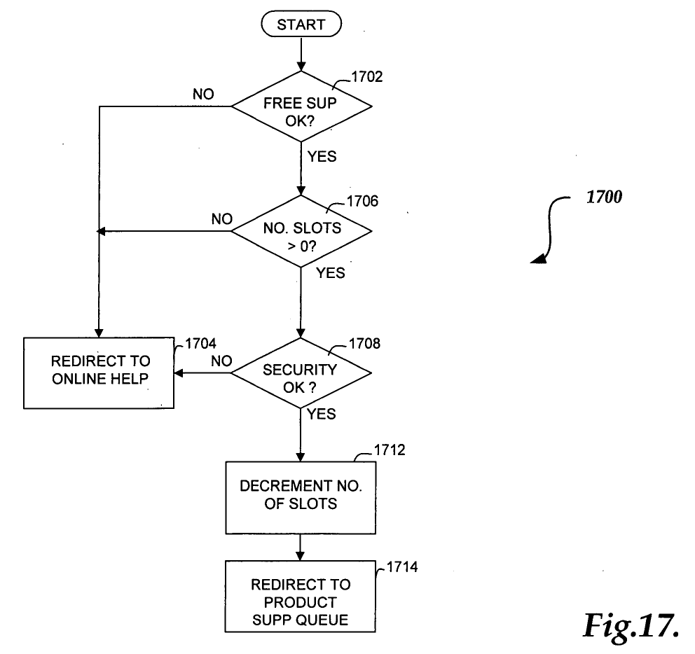

Referring to FIG. 17, a flow chart 1700 illustrates steps performed at a remote site after a user connects thereto in accordance with the application diagnostic system described herein. Processing begins at a first test step 1702 where it is determined if the results of the user diagnostics (passed via the parameter list constructed at the step 1612 of the flow chart 1600 of FIG. 16) warrant product support (e.g., free product support) for the user. Any appropriate criteria may be used at the test step 1702, such as criteria relating to application characteristics such as run-time stability (e.g., number of crashes per amount of time running, frequency with which the application hangs, etc.). In some embodiments, the possible criteria relate to the severity and frequency of problems the user is having with the application(s) for which free product support is sought, but of course other appropriate criteria may be used. In addition, it may be desirable to restrict users to a finite number of contact incidents (e.g., calls and/or email messages), such as five, after which additional product support is not warranted. Another criteria may be whether the diagnostic tests are able to pinpoint a possible cause of difficulties. The diagnostic tests detecting a possible cause of the problems may negate additional product support unless and until a user addresses the detected possible cause of the difficulties.

If it is determined at the test step 1702 that free product support is not warranted, then control transfers from the test step 1702 to a step 1704 where the user is redirected to generic online help, such as the type of online help that would be available to anyone that accessed the remote site.

If it is determined at the test step 1702 that free product support is warranted, then control transfers from the test step 1702 to a test step 1706 where it is determined if the number of available free product support slots is greater than zero. In some embodiments, the number of free product support slots is finite and is a function of the resources available for free product support (i.e., the number of available product support specialists) and the rate at which free product support incidents are handled. In an embodiment herein, it is desirable that anyone receiving free product support work with a product support specialist until the problem is resolved. Note also that the number of free product support slots may be allocated according to geography, language spoken by the user, or any other appropriate criteria so that, for example, there may be a free product support slots available in one particular region and/or in one particular language but not another.

If it is determined at the test step 1706 that there are no free product support slots available, then control transfers from the test step 1706 to the step 1704, discussed above, where the user is redirected to generic online help. Otherwise, if there are free product support slots available, then control transfers from the test step 1706 to a test step 1708 where it is determined if the user/application pass particular integrity checks. In an embodiment herein, it is desirable to not provide free product support to users that have not paid for the application software and/or users attempting to obtain free product support fraudulently. Accordingly, the integrity checks performed at the test step 1708 may be any checks appropriate to prevent these and other situations, as desired. If it is determined at the test step 1708 that the user has not passed integrity checks, then control transfers from the test step 1708 to the step 1704, discussed above, where the user is redirected to generic online help.

If it is determined at the test step 1708 that the user has passed integrity checks, then control transfers from the test step 1708 to a step 1712 where the number of free product support slots is decremented. Following the step 1712 is a step 1714 where the user is redirected to free product support. The free product support provided at the step 1714 may include, for example, an initial Web page with a case number and a form for the user to fill out to provide contact information. Of course, any appropriate mechanism for providing support may be used at the step 1714. For example, the user may be contacted by a product support specialist (or other appropriate person) online and/or by telephone. In some instances, the number of times a user may receive free product support may be limited (e.g., five times). This may be handled in the test at the step 1702 where, among other things, it is determined how many times a user has recently received free product support.

Note that the user may simply be placed in a queue of users waiting for free product support and that being placed in that queue may not guarantee eventual receipt of free product support. For example, the queue may be flushed periodically. In other embodiments, users placed in the queue are guaranteed to receive free product support. Note also that it is possible to alter the rules for determining which users receive free product support by, for example, adjusting the diagnostic thresholds, changing or eliminating some of the tests set forth in the flow chart 1700, etc. In an embodiment herein, it is possible to monitor the number (percentage) of users who are given free product support and the number of otherwise eligible users who turned away because there are no available free slots. Based on this data, it may be possible to adjust the criteria for eligibility so that no eligible users need to be turned away because all of the available free product support slots have already been used.

In addition, although the systems described herein mentions free product support, the system may be practiced using other types of product support, such as reduced cost product support, extensions of paid for product support, etc. Note also that for an embodiment of the system described herein, a user may not realize when and/or if they are eligible for free product support until the user receives the initial contact. Thus, for example, a user may be placed in a queue for free product support that is subsequently flushed prior to the user receiving the support and the user is directed to generic online help without ever being aware of having been placed in the free product support queue. Similarly, a user may meet all of the criteria for being eligible for free product support, but may nonetheless be directed to generic online help if there are no available slots (i.e., at the test step 1706).

Based on the foregoing, it should be appreciated that the various embodiments of the system described herein include a method, system, apparatus, and computer-readable medium for providing custom product support for a computer program based on levels of execution instability. The above specification, examples and data provide a complete description of the manufacture and use of the composition of the system described herein. Since many embodiments of the system described herein can be made without departing from the spirit and scope of the invention, the invention resides in the claims hereinafter appended.

We claim:

1. A method performed in a computer system for providing application support, comprising:
receiving data indicating application run-time characteristics;
determining severity of errors associated with running the application based on the data; and
determining if there are resources available to provide application support.

2. A method, according to claim 1, further comprising:
determining if the application passes integrity checks.

3. A method, according to claim 2, wherein the integrity checks include determining if the application is an evaluation version of the application.

4. A method, according to claim 1, further comprising:
if the severity of application errors exceeds a predetermined threshold and there are resources available for free application support, then providing free application support.

5. A method, according to claim 4, wherein providing free application support includes placing an instance in a queue of instances indicated as eligible to receive free application support.

6. A method, according to claim 5, wherein the queue is flushed periodically.

7. A method, according to claim 5, wherein the free application support is provided by at least one of: telephone and online interaction.

8. A method, according to claim 1, wherein determining the severity of errors associated with running the application includes running a plurality of diagnostics on a computer that hosts the application and providing the result thereof to the server.

9. A method, according to claim 1, further comprising:
determining if the user has access to a localized help desk.

10. A method, according to claim 9, further comprising:
if the severity of application errors exceeds a predetermined threshold and there are resources available for free application support and the user does not have access to a localized help desk, then providing the user with free application support.

11. A computer readable medium having computer executable instructions for performing the steps recited in claim 1.

12. A system having at least one processor that performs the steps recited in claim 1.

13. A method performed in a computer system for providing application support, comprising:
providing a queue for instances that merit application support, wherein each of the instances corresponds to application use by a user; and
providing a plurality of specific instances to the queue based on predetermined criteria, wherein placement in the queue of a particular instance is not apparent to a corresponding user until application support is provided.

14. A method, according to claim 13, further comprising:
removing an instance from the queue prior to providing application support.

15. A method, according to claim 13, wherein the predetermined criteria include severity of errors associated with running the application and resources available to provide application support.

16. A computer readable medium having computer executable instructions for performing the steps recited in claim 13.

17. A system having at least one processor that performs the steps recited in claim 13.

18. A method performed in a computer system for providing application support, comprising:
providing a queue for instances that merit application support, wherein instances are placed in the queue based on predetermined criteria;
placing a first instance in the queue;
determining that a second instance should not be placed in the queue; and
providing alternative support, different from the application support, in connection with the second instance.

19. A computer readable medium having computer executable instructions for performing the steps recited in claim 18.

20. A system having at least one processor that performs the steps recited in claim 18.
